(19) United States
(12) Patent Application Publication
(10) Pub. No.: US 2002/0026518 A1
(43) Pub. Date: Feb. 28, 2002

(54) Position information acquiring system and position information acquiring method

(76) Inventors: Hiroshi Ueda, Ome-shi (JP); Makoto Honda, Tachikawa-shi (JP)

Correspondence Address: BANNER & WITCOFF, 1001 G STREET N W, SUITE 1100, WASHINGTON, DC, 20001, US

(21) Appl. No.: 09/893,516

(22) Filed: Jun. 29, 2001

(30) Foreign Application Priority Data
Jun. 30, 2000 (JP) 2000-199002

(51) Int. Cl. G06F 15/177; G06F 15/16; G06F 7/00; G06F 17/30

(52) U.S. Cl. 709/229; 709/220; 707/10; 709/217

(57) ABSTRACT

A position information acquiring system to allow a user to access a private network and to acquire position information of a communicating terminal, wherein the private network comprises a user information server provided with a user-by-user telephone directory database to which the user sets up public information to release the position information of the communicating terminal, and configured to search the user-by-user telephone directory database to check the availability to release the position information when the user requests to acquire the position information of the portable communication terminal, and a terminal position information management server to acquire the position information of the portable communication terminal and then to send it to the user information server when receiving a notice from the user information server that the position information should be released.

### CROSS-REFERENCE TO RELATED APPLICATIONS

This application is based upon and claims the benefit of priority from the prior Japanese Patent Application No. 2000-199002, filed Jun. 30, 2000, the entire contents of which are incorporated herein by reference.

### BACKGROUND OF THE INVENTION

The present invention is related to a position information acquiring system and a position information acquiring method.

Presently, a position information service has been commercialized as a service to inform position information of the user's own communication terminal to a predetermined party by means of the position information of portable communication terminals.

Further, there is also a PIM (Personal Information Management) service available, where the portable communication terminal users can obtain their personal addresses on the server provided by the service provider and can use the service from their portable communication terminals.

However, by means of the position information service described above, it is not possible to display the easy-to-understand information simply and efficiently on the terminal, obtaining the position information of the portable communication terminal user being input in the user's own telephone number database.

In addition, in the field of PIM (Personal Information Management), the position information service to acquire the positional data has so far not been realized.

### BRIEF SUMMARY OF THE INVENTION

It is an object of present invention to provide a position information acquiring system and a position information acquiring method, which can obtain the position information of a plurality of portable information terminals by a simple operation and can set up a selection either to release or not to release the detailed position information.

To attain the aforementioned object, a position information acquiring system according to a first aspect of the present invention, to allow a user to a position information acquiring system to allow a user to acquire position information of a communication terminal by accessing a private network via a public network, wherein the private network comprises;

a user information server provided with a user information database containing a field to which the user sets up public information to release the position information of the communicating terminal, and configured to search the user information database to check whether or not to release the position information when the user requests to acquire the position information of the communication terminal, and,

a terminal position information management server to acquire the position of the communication terminal to send it to the user information server when receiving a notice from the user information server that the position information can be released.

A position information acquiring method according to a second aspect of the present invention, to allow a user to a position information acquiring method to allow a user to acquire position information of a communication terminal by accessing a private network via a public network comprises,

a step of searching by a user information server a user information database containing a field to which the user sets up public information to release the position information when the user requests to acquire the position information of the communication terminal, and checking the availability of the release of the position information, and

a step of acquiring the position information of each communication terminal via the terminal position information management server to send it to the user information server when receiving a notice from the user information server that the position information is acquirable.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a diagram showing the constitution of the position information acquiring system to which the first embodiment of the present invention is applied;

FIGS. 2A through 2D are charts each showing an example of the user-by-user telephone directory database 18;

FIG. 3 is a chart showing the acquired position information of the communicating parties in a list form;

FIG. 4 is a chart showing the user-by-user telephone directory database wherein group fields capable of setting up group information for grouping the communicating parties listed in the telephone directory are provided;

FIG. 5 is a chart showing an example of a database wherein position information release set up flags to indicate whether or not to release the user's own position information to friends and companies respectively as group names shown in FIG. 4, has been set up in the database;

FIG. 6 is a chart showing a user-by-user schedule database capable of setting up the user's own schedule information by the user;

FIG. 7 is a chart showing user-by-user position information released area set up database;

FIG. 8 is an illustration showing an example of specifying a release area by means of pen input;

FIG. 9 is an illustration showing an example of specifying a search area by means of pen input;

FIG. 10 is a chart showing an example of a search area condition set up database;

FIGS. 11A and 11B are charts each showing an example of a user attribute set up database; and

FIGS. 12A and 12B are charts each showing an example of a user attribute condition set up database.

### DETAILED DESCRIPTION OF THE INVENTION

This embodiment of the present invention is characterized by containing a process to access from a portable communication terminal to an user information server through the provider's network when acquiring a position information of an other portable communication terminal from a portable communication terminal, and to set up an option either to release or not to release position information or to set up a search area, while using the obtained position information data. The details of the embodiment are explained in the following with reference to the drawings.

### First Embodiment

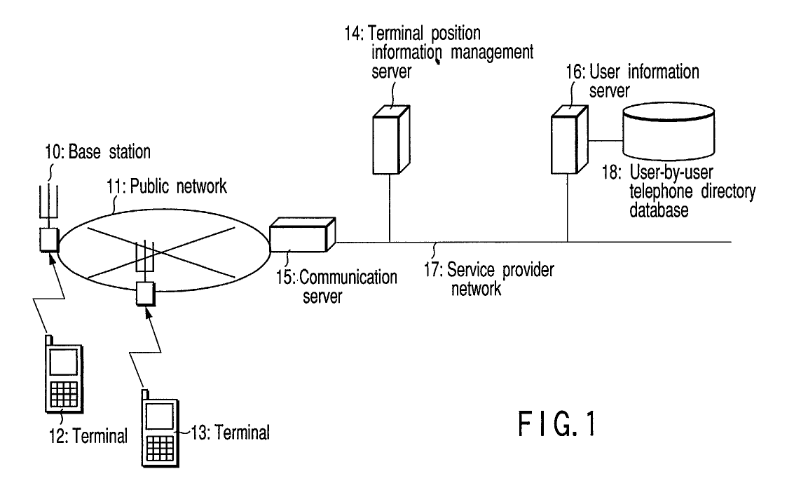

FIG. 1 is a diagram showing the constitution of the position information acquiring system according to the first embodiment of the present invention, and the system is constituted by portable communication terminals 12 and 13, public network 11, and service provider network 17. In the public network 11, a base station 10 is arranged.

The service provider network 17 comprises a communication server 15 for controlling communication between the portable communication terminals 12 and 13, and the service provider network 17 via the public network 11, a terminal position information management server 14 to acquire the position information of each portable communication terminal 12 and 13 and then to feed the position information to the user information server 16, and a user information server 16 to store and control the user-by-user telephone directory database 18 of users using their portable communication terminals 12 and 13. The user-by-user telephone directory database 18 contains position information release set up flags in one of the fields to set up an option either to release or not to release the position information corresponding to the communicating party. A description of the position information release set up flag will be given in detail herein later.

Although the position information is acquired by the portable communication terminal in the constitution specified above, such a position information acquiring function may be provided to the base station 10. Each user can access the user-by-user telephone directory database 18 for the use of the user by using the portable communication terminals 12 and 13 and can set up an option either to release or not to release the position information in addition to the setting up and the search of telephone directory data.

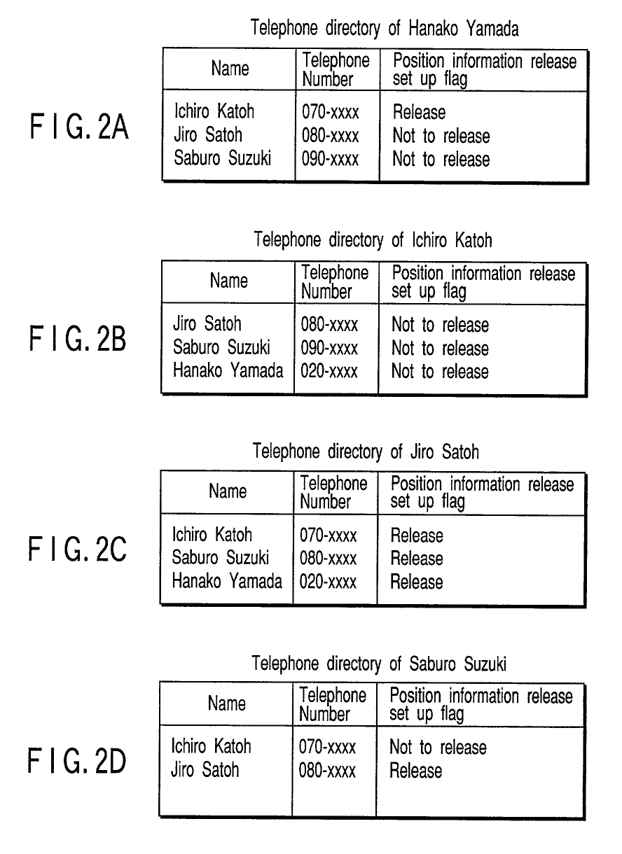

FIGS. 2A through 2D are charts each showing an example of the context of the user-by-use telephone directory database 18 described above, wherein telephone numbers of four users are displayed. Generally, a personal telephone directory comprises names and telephone numbers of the communicating parties, but a position information release set up flag to set up an option either to release or not to release the position information of the portable communication terminal to the communicating party is also contained in the database.

For example, when the portable communication terminal 12 is being carried, and the user requests the user information server 16 to search the user-by-user telephone directory database 18 for acquiring the position information of the portable communication terminal 13 of the communicating party, the user information server 16 starts searching the personal telephone directory of the user and checks names listed in the telephone directory as the searched subjects thereby to search each personal telephone directory of the party. In searching for each personal telephone directory, the server also checks the position information release flag corresponding to the requesting user. When the position information is set up to released to the requesting user, the server 16 asks the terminal position information management server 14 for the position information on the party being subjected to searching.

The terminal position information management server 14 requests the position information of each party being subjected to searching, from either the corresponding portable communication terminal 13 or the base station 10, or both, acquires the position information and sends the telephone directory data including the position information to the portable communication terminal 12 of the requesting user. The potable communication terminal 12 of the requesting user displays the received telephone directory data on the screen of the terminal.

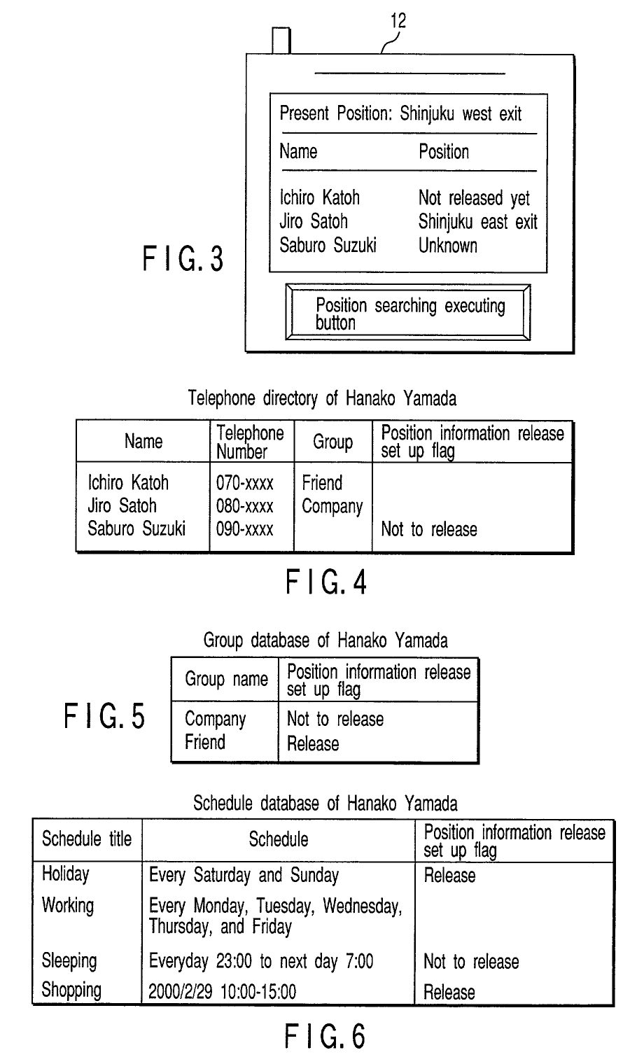

FIG. 3 shows an example of the screen display for the acquired data in a list form. Although this example is a case in which the user is informed of the data by displaying output letters on the screen of the terminal, any other easy communicating means applicable to the portable communication terminal, such as a graphic display or sound output, can also be employed for this embodiment.

### Second Embodiment

Now, the second embodiment of the present invention is explained in the following. In this embodiment, setting up of an option whether to release or not to release the position information according to the group to which the communicating party belongs can be made.

Namely, as shown in FIG. 4, a group field that enables the user to set up the group information for grouping communicating parties listed in the telephone directory is newly provided in the user-by-user telephone directory database. In FIG. 4, group names of “Friend” and “Company” are set up in the telephone directory database. In addition, a user-by-user group database to be set up by the user with information for selecting either “Release” or “Not to release” of the position information to the corresponding group is also provided in the database. In FIG. 5, an example being set up with the position information release set up flag depending on each group names of “Friend” and “Company” presented in FIG. 4 is shown.

### Third Embodiment

Now, the third embodiment of the present invention is explained in the following. In this embodiment, the release of the position information is executed according to the user's schedule.

Namely, as shown in FIG. 6, each user has a user-by-user schedule database capable of setting up the user's own schedule information by itself, and the position information release set up flag to set up an option either to release or not to release the position information according to the corresponding schedule is provided in one of the fields of the database.

When a requirement for the position information of the communicating party is made by the user, the user information server 16 accesses the user-by-user schedule database to refer the restriction status based on the setting up and then to determine either to release or not to release the position information according to the schedule information.

### Fourth Embodiment

The fourth embodiment of the present invention is now explained in the following. This embodiment is characterized by allowing to set up an option either to release or not to release the position information according to the area condition.

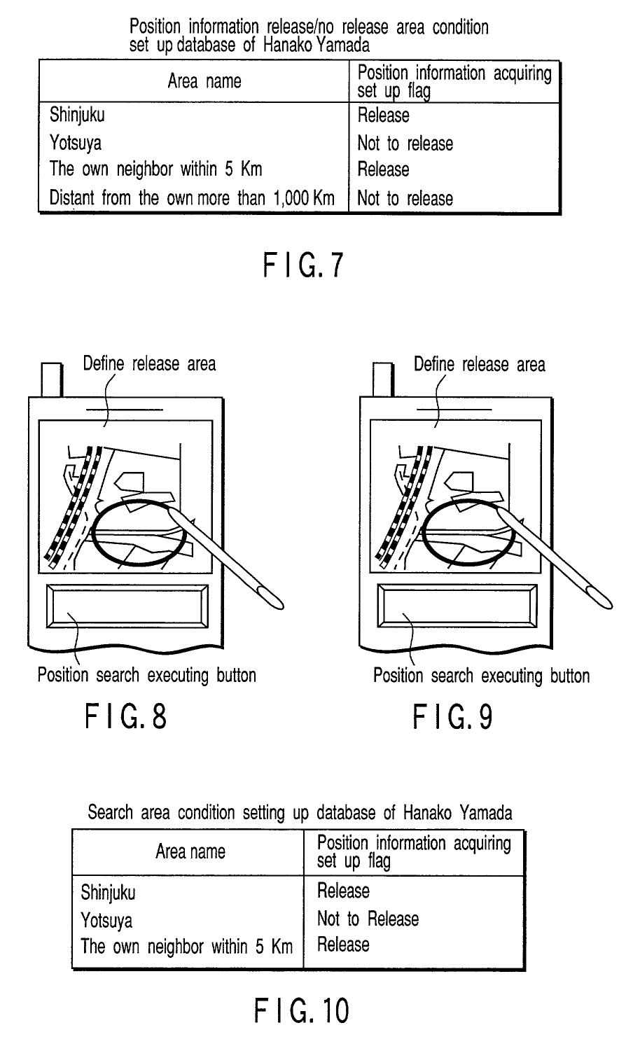

As the first example of the fourth embodiment, an option either to release or not to release the user's own position information in a limited area is set up. In this setting up, the user has a user-by-user position information release area set up database to which the user can set up an area wherein the user's own position information is released. As shown in FIG. 7, the user-by-user position information release area set up database has a position information release set up flag as one of the fields to set up an option either to release or not to release the position information depending upon the corresponding position information release area.

When release of position information of a communicating party is requested by the user, the user information server 16 accesses the user-by-user position information release area set up database and restricts the release of the position information based on the area condition by referring to the restriction applied to the information.

In this method, the option either to release or not to release the user's own position information in the limited area can be set up by the user.

As an example of setting up the limitation to the area whether to release or not to release the position information, there is no fixed input method, so that other than the method of inputting an area name from the terminal to limit the area, there is also a method using a touch screen and pen to enclose a map displayed on the terminal screen of the communication terminal. FIG. 8 shows an example of the method of limiting the release area by pen input to release the position information.

The second example for the fourth embodiment is characterized by allowing an option either to release or not to release the user's own position information in the area other than the limited area. In this example, the user can set up by itself from the terminal an option either to release or not to release the user's own position information in the area other than the limited area can be set up by the user, based on a method similar to that explained in the first example.

The third example of the fourth embodiment is characterized by allowing to set up an option either to release or not to release the user's own position information in the neighboring area. In this example, the user can set up by him- or herself from the terminal a distance from the user's own position in which distance an option either to release or not to release the user's own position information is allowed, based upon the method as explained in the first example.

The fourth example of the fourth embodiment is characterized by allowing to set up an option either to release or not to release the user's own position information in an area other than the neighboring area. In this example, the user can set up by him- or herself from the terminal an option either to release or not to release the user's own position information in an area other than the range of from the user's own position to a limited distance, based upon the method as explained in the first example.

The user-by-user telephone directory database 18 in the fifth example of the fourth embodiment contains user-by-user position information release/no release areas for allowing the user to set up an option either to release or not to release the position information depending upon the fixed condition of the position information release/no release areas.

When the user is requested to provide the position information of a communicating party, the user information server 16 accesses the user-by-user telephone directory database 18 and restricts the release of the position information based on the area condition by referring to the restriction being applied on the information. In FIG. 8, an example of the position information release/no release area condition database is given.

### Fifth Embodiment

The fifth embodiment of the present invention is characterized by appropriately combining the second, the third and the fourth embodiments described above. According to combining such embodiments appropriately, the setting up of an option either to release or not to release the detailed position information may be feasible.

For example, it can be feasible to release the user's own position information to a communicating party only in the case that a person is present in Shinjuku or Yotsuya on every Saturday and Sunday during the afternoon and the communicating party is one of his friends.

### Sixth Embodiment

Now, the sixth embodiment of the present invention is explained in the following. The characteristic feature of this embodiment is to allow searching for the communicating parties based on the area condition being set up.

In the first example of the sixth embodiment, searching in a limited area is performed. The user firstly specifies an area to be searched from the terminal and then shifts the position information to be acquired in accordance with the specified restriction, thereby to display the party being present only in the specified area. As an example of the limitation of the searching area, though there is no specific limitation in the input method, a method to limit an area by inputting an area name from the terminal, or a method to arbitrarily enclose a map displayed on the terminal screen with a pen to limit the area if the portable communication terminal is mounted with a display system which accepts pen input.

FIG. 9 shows a practical example of limiting the searching area on the screen by the method of pen input.

The second example of the sixth embodiment enables to execute searching in an area other than the limited area. In this example, the user defines the area that the user does not want to include into the area to be searched from the terminal and then selects the position information to be acquired in accordance with the restriction based on the limitation, thereby displaying on the screen only the parties who are out of the limited area.

The third example of the sixth embodiment enables to execute neighbor searching. In this example, the user defines a distance from the user's own position in a certain radius and then selects the required position information in accordance with the restriction based on the limitation, thereby displaying on the screen only the parties who are present within the defined range.

The fourth example of the fourth embodiment enables to execute searching in the area other than the neighboring area. In this example, the user selects a distance from the user's position to define the area in which searching is not performed and then selects the required position information in accordance with the restriction based on the limitation to thereby display on the screen only the parties who are present out of the area.

The fifth example of the fifth embodiment enables the user who wants to acquire the position information to access the user-by-user searching area condition set up database to set up the area condition, wherein, when acquiring the position information, the terminal position management server accesses the searching area condition set up database and selects the required position information in accordance with the restriction based on the limitation being set up to thereby display on the screen only the parties who are within the limited area. In FIG. 10, an example of the searching area condition set up database is shown.

### Seventh Embodiment

The seventh embodiment of the present invention is now explained in the following. This embodiment is characterized by facilitating an option to be set up either to release or not to release the position information depending upon the user attribute condition of a communication party.

In this embodiment, the position information acquiring system contains a user-by-user attribute set up database to which each user can set up by him- or herself their attributes and a user-by-user attribute condition set up database to which each user can define the user attribute conditions for communication parties. The user-by-user attribute condition set up database has a position information release set up flag to set up an option either to release or not to release the position information corresponding to the user attribute in one of the fields.

Namely, as a result of containing such database, an access by the user to the user attribute set up database to express the user's own attributes and the values and an access to the user attribute condition set up database to which the user can set up an option either to release or not to release the position information depending upon the attribute information of a party who is executing searching on the user may be facilitated.

When receiving any request to search the position information for a certain communicating party, the user information server 16 accesses the user-by-user attribute set up database and the user-by-user attribute condition set up database, then checks the conformance between the attribute and the condition of the party being searched, to take an option either to release or not to release the position information.

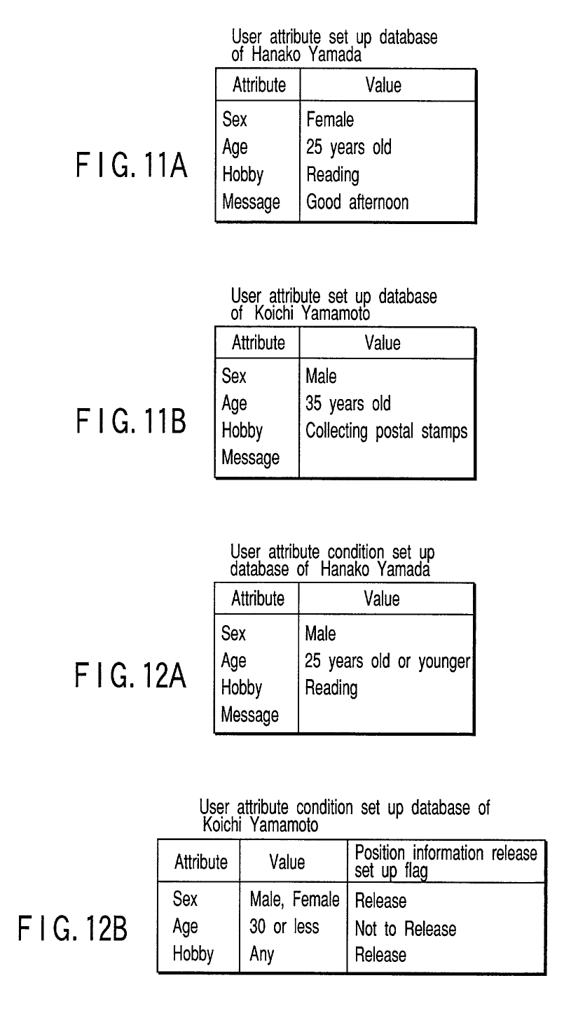

As the user's attribute to be written in the two databases mentioned above, sex, age, hobby and the like may be given, however, any attributes may be written in the database, if they may be processed into data suitable for the checking process of the conditions and if they are integrated attributes between the user attribute database owned by the communicating party who is executing the searching and the user attribute condition database owned by the party to be searched. In FIGS. 11A and 11B, an example of the user attribute set up database is shown. And, in FIGS. 12A and 12B, an example of the user attribute condition set up database is shown.

In this embodiment, even though the telephone directory information of the user to execute the search is not listed in the telephone directory of the user to be searched, the party to be searched may release the position information when the attribute information of the party to execute searching complies with the condition set up by the party to be searched.

In the modified example of the seventh embodiment, the user may acquire the value in the user attribute set up database by him- or herself and may make an option to restrict the releasing of the information in the user attribute set up database to the parties who have made an option not to release the telephone directory. In addition, the user may arbitrarily define the detailed limitation for each attribute whether it is released or not to be released.

### Eighth Embodiment

The eighth embodiment is characterized in that the embodiment is constituted by appropriately combining the third embodiment, the fourth embodiment and the seventh embodiment. With this combined embodiment, setting up the option whether to release or not to release the user's own position information to the communicating parties who complies with the more detailed condition for searching is enabled.

For example, with this embodiment, a restricted release of the position information and the user attribute set up database only under a condition that the user is present in either Shinjuku or Yotsuya during the afternoon on holiday on Saturday or Sunday every week and only to a party younger than 25 years old and having a hobby of reading, is enabled.

According to the present invention, the protection of the detailed position information on the use of a portable communication terminal is realized, because the users can set up detailed limitation as to the release of the position information from their portable communication terminal. Further, the users can acquire the position information in the block from a plurality of portable communication terminals by a simple operation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A position information acquiring system to allow a user to acquire position information of a communication terminal by accessing a private network via a public network, wherein the private network comprises;
a user information server provided with a user information database containing a field to which the user sets up public information to release the position information of the communicating terminal, and configured to search the user information database to check whether or not to release the position information when the user requests to acquire the position information of the communication terminal, and,
a terminal position information management server to acquire the position of the communication terminal to send it to the user information server when receiving a notice from the user information server that the position information can be released.

2. The position information acquiring system according to claim 1, wherein the user information database contains a group field capable of setting up group information to group communicating parties listed in the user information database and the public information is set up corresponding to each group.

3. The position information acquiring system according to claim 1, wherein the user information database contains a schedule field to which the user can set up the user's own schedule information and the public information is set up corresponding to each schedule.

4. The position information acquiring system according to claim 1, wherein the user information database contains an information release area set up field to which the user can set up user's own position information and the public information is set up corresponding to each release area.

5. A position information acquiring system to allow a user to acquire position information of a communication terminal by accessing a private network via a public network, wherein the private network comprises;
a user information server provided with a user information database containing a user-by-user search area condition set up field to which the user can set up an area to search the position of the communicating terminal and a field to which information is set up to indicate whether or not to acquire the position information corresponding to each search area, and configured to search the user information database to check the availability to acquire the position information when the user requests to acquire the position information of the communication terminal, and
a terminal position information management server to acquire the position information of each communication terminal thereby to send the position information to the user information server when receiving a notice from the user information server that the position information is acquirable.

6. A position information acquiring system to allow a user to acquire position information of a communication terminal by accessing a private network via a public network, wherein the private network comprises;
a user-by-user user attribute set up database to which the user can set up the user's own user attributes,
a user-by-user user attribute condition set up database to which the user can set up user attribute conditions for a communicating party and containing a field to which the user sets up public information to release the position information depending upon the corresponding user attribute conditions,
a user information server to search the user attribute condition set up database to check the availability to release the position information when the user requests to acquire the position information of the communication terminal, and
a terminal position information management server to acquire the position information of each communication terminal to send it to the user information server when receiving a notice from the user information server that the position information in acquirable.

7. A position information acquiring method to allow a user to acquire position information of a communication terminal by accessing a private network via a public network comprises,
a step of searching by a user information server a user information database containing a field to which the user sets up public information to release the position information when the user requests to acquire the position information of the communication terminal, and checking the availability of the release of the position information, and
a step of acquiring the position information of each communication terminal via the terminal position information management server to send it to the user information server when receiving a notice from the user information server that the position information is acquirable.

8. The position information acquiring method according to claim 7, wherein the user information database contains a group field to which information to group the communicating parties listed in the user information database is set up, and the public information is set up corresponding to each group.

9. The position information acquiring method according to claim 7, wherein the user information database contains a schedule field to which each user is set up the user's own schedule information, and the public information is set up corresponding to each schedule.

10. The position information acquiring method according to claim 7, wherein the user information database contains a release area set up field to which each user set up the release area for releasing the user's own position information, and the public information is set up corresponding to each release area.

11. A position information acquiring method to allow a user to acquire position information of a communication terminal by accessing a private network via a public network comprises,
a step of searching by a user information server a user information database, which contains an user-by-user search area condition set up field, to which each user can set up an area for searching the position of a communicating terminal when the user requests to acquire the position information of the communication terminal and a field to which public information indicating whether or not to acquire the position information corresponding to each search area is set up, and checking the availability to acquire the position information, and,
a step of acquiring the position information of each communication terminal via the terminal position information management server and then to send it to the user information server when receiving a notice from the user information server that the position information is acquirable.

12. A position information acquiring method to allow a user to acquire position information of a communication terminal by accessing a private network via a public network comprises,
a step of searching by a user information server a user-by-user user attribute set up database, to which each user can set up the user's own attribute when each user requests to acquire the position information of a communication terminal, and a user-by-user user attribute condition set up database, to which each user can set up the user attribute condition and which contains a field to which the user sets up public information to release the position information depending upon the corresponding user attribute condition, and checking the availability to release the position information, and,
a step of acquiring the position information of each communication terminal via the terminal position information management server and then to send it to the user information server when receiving a notice from the user information server that the position information should be released.
